(19) United States
(12) Patent Application Publication
(10) Pub. No.: US 2024/0406988 A1
(43) Pub. Date: Dec. 5, 2024

(54) RECEIVED SIGNAL QUALITY DEPENDENT PDCCH MONITORING ADAPTATION

(71) Applicant: QUALCOMM Incorporated, San Diego, CA (US)

(72) Inventors: Jae Ho RYU, San Diego, CA (US); Jae Won YOO, San Diego, CA (US); Hobin KIM, San Diego, CA (US); Hari SANKAR, San Diego, CA (US)

(21) Appl. No.: 18/326,973

(22) Filed: May 31, 2023

(51) Int. Cl. H04W 72/542; H04L 5/00; H04W 72/23

(52) U.S. Cl. CPC H04W 72/542; H04L 5/0092; H04W 72/23

(57) ABSTRACT

Apparatuses and methods for received signal quality dependent PDCCH monitoring adaptation are described. An apparatus is configured to receive, from a network node, multiple SSS group configurations, and receive an indication of a first SSS group configuration from the multiple SSS group configurations based on a first received signal quality of the UE. The apparatus is also configured to monitor first PDCCH candidates associated with the first SSS group configuration. Another apparatus is configured to configure, for a UE, multiple SSS group configurations, and provide an indication of a first SSS group configuration from the multiple SSS group configurations based on a first received signal quality of the UE. The apparatus is also configured to provide a PDCCH for the UE in at least one PDCCH candidate of the first SSS group configuration.

### TECHNICAL FIELD

The present disclosure relates generally to communication systems, and more particularly, to wireless communications utilizing search space monitoring.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus (e.g., a user equipment (UE) or portion thereof) is configured to receive, from a network node, multiple search space set (SSS) group configurations. The apparatus is configured to receive an indication of a first SSS group configuration from the multiple SSS group configurations based on a first received signal quality of the UE. The apparatus is configured to monitor first physical downlink control channel (PDCCH) candidates associated with the first SSS group configuration.

In the aspect, the method includes receiving, from a network node, multiple SSS group configurations. The method also includes receiving an indication of a first SSS group configuration from the multiple SSS group configurations based on a first received signal quality of the UE. The method also includes monitoring first PDCCH candidates associated with the first SSS group configuration.

In an aspect of the disclosure, a method, a computer-readable medium, and an apparatus are provided. The apparatus is configured to configure, for a UE, multiple SSS group configurations. The apparatus is also configured to provide an indication of a first SSS group configuration from the multiple SSS group configurations based on a first received signal quality of the UE. The apparatus is also configured to provide a PDCCH for the UE in at least one PDCCH candidate of the first SSS group configuration.

In the aspect, the method includes configuring, for a UE, multiple SSS group configurations. The method also includes providing an indication of a first SSS group configuration from the multiple SSS group configurations based on a first received signal quality of the UE. The method also includes providing a PDCCH for the UE in at least one PDCCH candidate of the first SSS group configuration.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example configurations for monitoring adaptations based on traffic conditions, in accordance with various aspects of the present disclosure.

FIG. 5 is a call flow diagram for wireless communications, in accordance with various aspects of the present disclosure.

FIG. 6 is a diagram illustrating example SSS group configurations for monitoring adaptations based on signal quality, in accordance with various aspects of the present disclosure.

FIG. 7 is a diagram illustrating example SSS group configurations for monitoring adaptations in component carriers based on signal quality, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

Wireless communication networks, such as a 5G NR network, may enable search space monitoring for DL channels, such as PDCCH. For example, a 5G NR UE may support DL channel monitoring capacities for a given number of blind detections (BDs) and control channel elements (CCEs) associated with different subcarrier spacing (SCS) configurations. A UE may be configured with a number of SSSs per carrier where DL channel candidates are configured by a base station in association with aggregation levels, and different SSS groups may be configured for varying traffic conditions.

However, existing PDCCH monitoring for large numbers of PDCCH candidates and PDCCH processing for large number of CCEs may lead to issues with processing, delays, and power consumption. For instance, increased hardware complexity for PDCCH processing (e.g., channel estimation, de-mapping, decoding, memory, etc.) may result from monitoring/processing large numbers of PDCCH candidates/CCEs. Additionally, increased PDCCH decoding delays (e.g., impacts in overall DL/UL processing timelines, etc.), as well as increased power consumption (e.g., due to delays entering usleep (or “micro-sleep”)), may also result from monitoring/processing large numbers of PDCCH candidates/CCEs. Further, existing monitoring does not provide for configuring SSS groups based on received signal quality at a UE.

Various aspects relate generally to wireless communications systems and search space monitoring for wireless devices. Some aspects more specifically relate to received signal quality dependent DL (e.g., PDCCH) monitoring adaptations. In aspects, signal quality, or received signal quality, may be referred to as UE “geometry” that is related to DL signal quality/condition, and may include, without limitation, a signal-to-noise ratio (SNR), a signal-interference-to-noise ratio (SINR), and/or the like. In one example, a UE may receive, from a network node, multiple SSS group configurations, and may receive an indication of a first SSS group configuration from the multiple SSS group configurations based on a first received signal quality of the UE. The UE may monitor first PDCCH candidates associated with the first SSS group configuration. In another example, a network node, e.g., a base station, gNB, etc., may configure, for a UE, multiple SSS group configurations. The network node may provide an indication of a first SSS group configuration from the multiple SSS group configurations based on a first received signal quality of the UE. Additionally, the network node may provide a PDCCH for the UE in at least one PDCCH candidate of the first SSS group configuration.

Particular aspects of the subject matter described in this disclosure can be implemented to realize one or more of the following potential advantages. In some examples, by configuring multiple SSS group configurations for a UE and activating a given SSS group configuration based on the received signal quality (e.g., geometry or SINR) of the UE, the described techniques can be used to decrease processing utilization, delays, and power consumption at the UE. In some examples, by reducing the numbers of DL channel candidates to be monitored and the number of CCEs to be processed, the hardware complexity for DL channel processing (e.g., channel estimation, de-mapping, decoding, memory, etc.), the PDCCH decoding delay (e.g., impacts of the overall DL/UL processing timelines), and the power consumption (e.g., due to delays in entering usleep) may be decreased.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

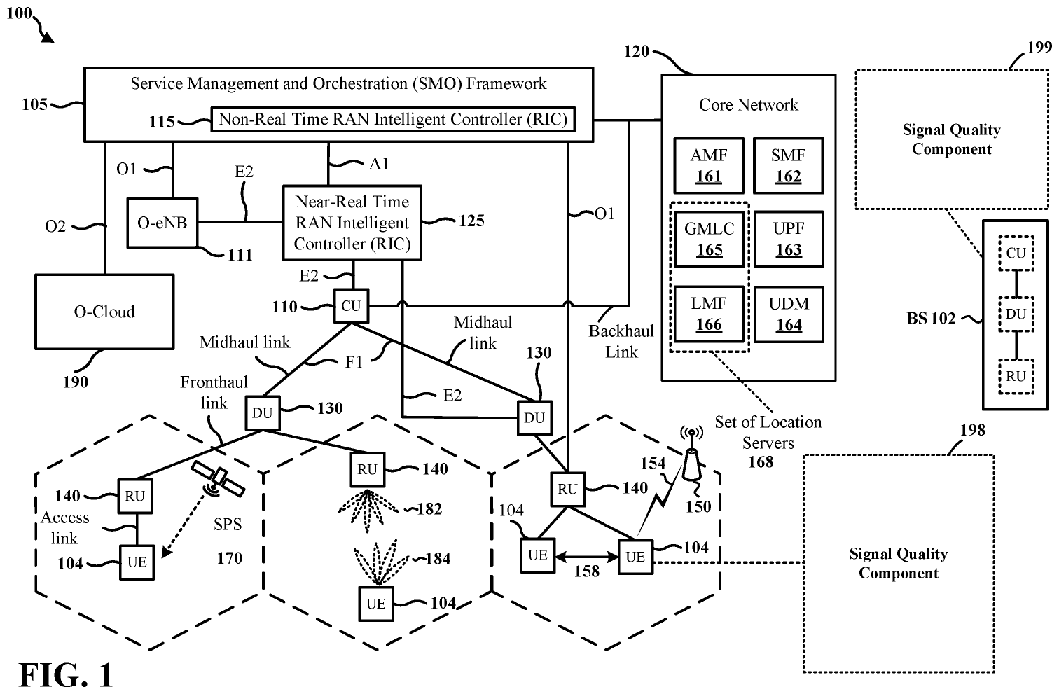

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz—7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a signal quality component 198 (“component 198”) that may be configured to receive, from a network node, multiple SSS group configurations. The component 198 may be further configured to receive an indication of a first SSS group configuration from the multiple SSS group configurations based on a first received signal quality of the UE. The component 198 may be further configured to monitor first PDCCH candidates associated with the first SSS group configuration. The component 198 may be configured to receive, from the network node, a switching indication to switch to monitoring second PDCCH candidates associated with a second SSS group configuration from the multiple SSS group configurations based on a change in the first received signal quality of the UE to a second received signal quality. The component 198 may be configured to monitor the second PDCCH candidates associated with the second SSS group configuration. In certain aspects, the base station 102 may have a signal quality component 199 (“component 199”) that may be configured to configure, for a UE, multiple SSS group configurations. The component 199 may be further configured to provide an indication of a first SSS group configuration from the multiple SSS group configurations based on a first received signal quality of the UE. The component 199 may be further configured to provide a PDCCH for the UE in at least one PDCCH candidate of the first SSS group configuration. The component 199 may be configured to obtain at least one indication for received signal quality of the UE. The component 199 may be configured to provide, for the UE, a switching indication to switch to monitoring second PDCCH candidates associated with a second SSS group configuration from the multiple SSS group configurations based on a change in the first received signal quality of the UE to a second received signal quality. Accordingly, aspects herein provide for received signal quality (e.g., “geometry”) dependent DL monitoring adaptations utilized UE signal quality, or received signal quality, to adapt monitoring through configurations of SSS groups that correspond to the received signal quality at the UE, and by configuring multiple SSS group configurations for a UE and activating a given SSS group configuration based on the received signal quality of the UE, the described aspects herein may be used to decrease processing utilization, delays, and power consumption at the UE. UEs may thus be configured to reduce the number of DL channel candidates to be monitored and the number of CCEs to be processed, which may reduce the hardware complexity for DL channel processing (e.g., channel estimation, de-mapping, decoding, memory, etc.), the PDCCH decoding delay (e.g., impacts of the overall DL/UL processing timelines), and the power consumption (e.g., due to delays in entering usleep).

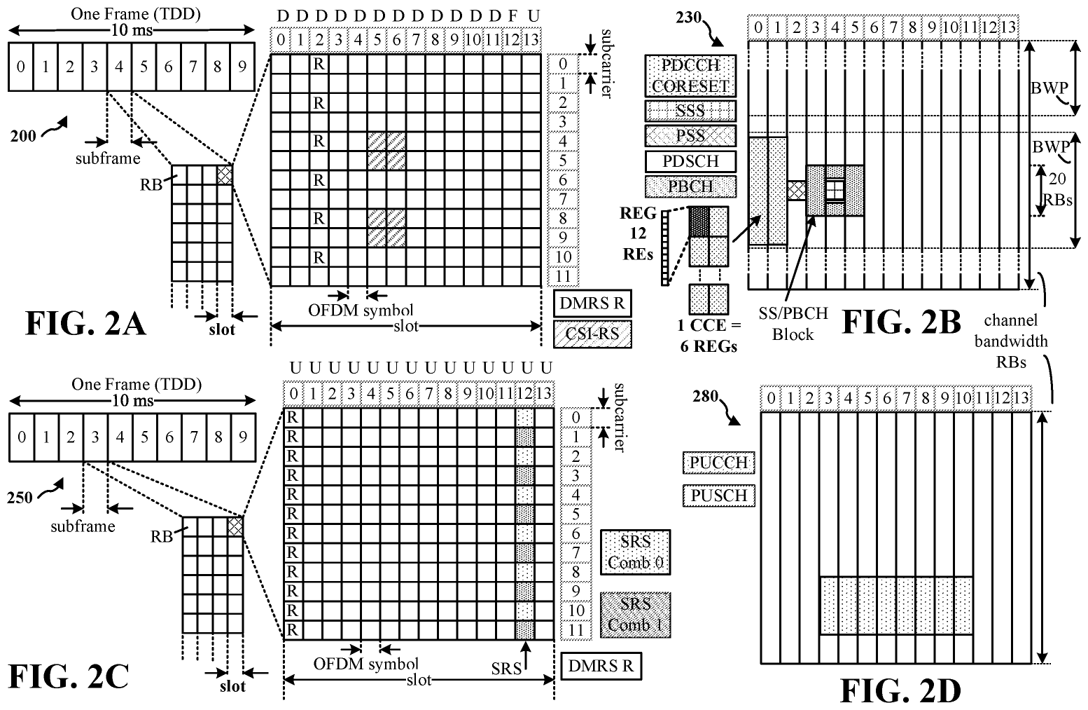

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

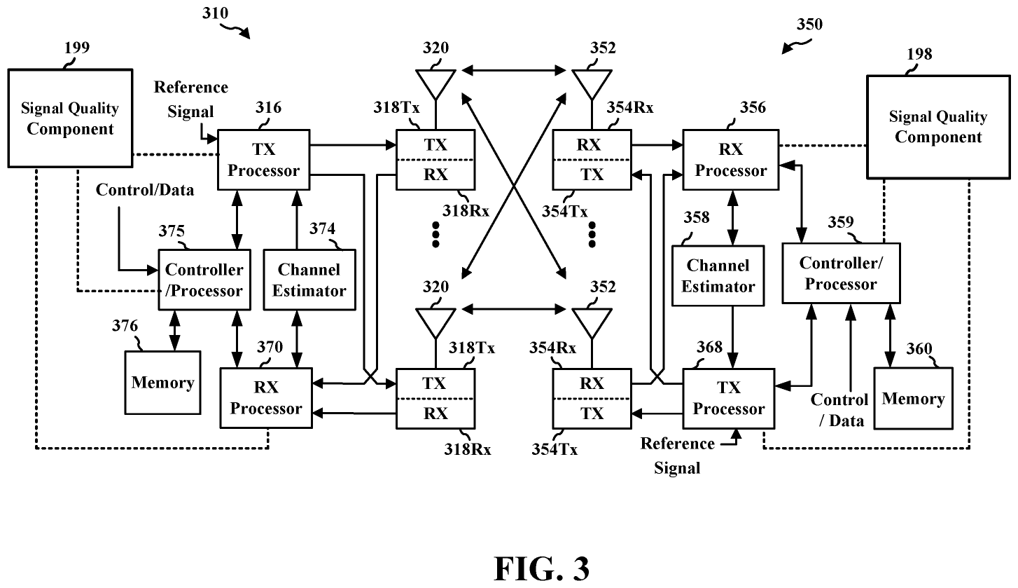

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the < >component 199 of FIG. 1.

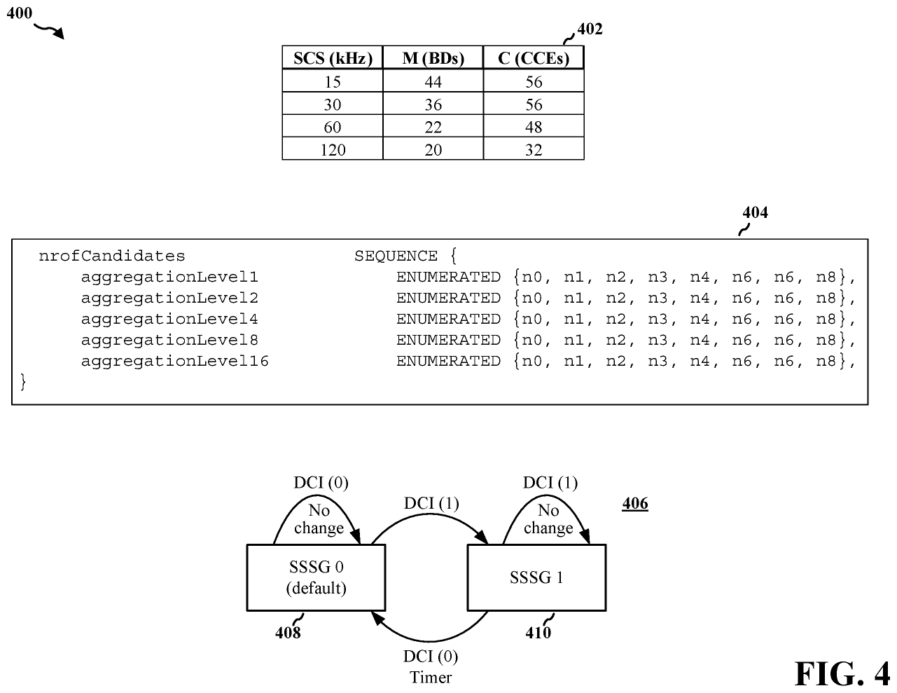

FIG. 4 is a diagram 400 illustrating example configurations for monitoring adaptations based on traffic conditions, in various aspects. Diagram 400 illustrates a configuration 402, a configuration 406, and a configuration 408.

The configuration 402 shows a configuration for PDCCH monitoring with respect to different SCS options. For example, a NR UE may be configured by a base station (e.g., a gNB) to support PDCCH monitoring capacities as shown in the configuration 402. As illustrated, in every slot, a NR UE may be configured to monitor at least ‘M’ PDCCH candidates and process a number ‘C’ of non-overlapping CCEs.

The configuration 404 shows a configuration for SSSs. For example, a NR UE may be configured by a base station (e.g., a gNB) to support up to 10 (ten) SSSs per carrier. In each SSS, the UE may be configured for a number of PDCCH candidates per aggregation level. PDCCH candidates with different aggregation levels may target different signal quality/geometry regimes. For instance, an aggregation level of 1 or 2 may be configured for a high signal quality/geometry regime, and an aggregation level of 8 or 16 may be configured for a low signal quality/geometry regime. In some SSS configurations for NR deployments, a base station/gNB may configure PDCCH candidates for all aggregation levels. An SSS configuration may be a semi-static configuration, however, and may not be adaptable to a signal quality/geometry condition of a UE. For this reason, NR UEs may be configured to support the monitoring of large number of PDCCH candidates, which may correspond to processing large numbers of CCEs.

The configuration 406 shows a configuration for traffic-dependent PDCCH monitoring adaptation. For instance, SSS group switching for PDCCH monitoring adaptation may be configured for a UE based on its traffic condition. A base station/gNB may configure a UE with two sets of SSS groups, where a SSS group 0 408, which may be the default SSS group, configures dense (e.g., every slot) PDCCH monitoring for the UE, and a SSS group 1 410 configures sparse (e.g., every ‘N’ slots) PDCCH monitoring. A 1-bit field in DCI may indicate switching between the SSS group 0 408 and the SSS group 1 410, while a timer-based switching from the SSS group 1 410 to the SSS group 0 408 may be utilized. If the DCI indicates the SSS group 0 408 while it is configured, no change may take place. Likewise, if the DCI indicates the SSS group 1 410 while it is configured, no change may take place.

As noted above, existing PDCCH monitoring for large numbers of PDCCH candidates and PDCCH processing for large number of CCEs may lead to issues with processing, delays, and power consumption. For instance, increased hardware complexity for PDCCH processing (e.g., channel estimation, de-mapping, decoding, memory, etc.) may result from monitoring/processing large numbers of PDCCH candidates/CCEs. Additionally, increased PDCCH decoding delays (e.g., impacts in overall DL/UL processing timelines, etc.), as well as increased power consumption (e.g., due to delays entering usleep (or “micro-sleep”)), may also result from monitoring/processing large numbers of PDCCH candidates/CCEs. Further, existing monitoring does not provide for configuring SSS groups based on received signal quality at a UE.

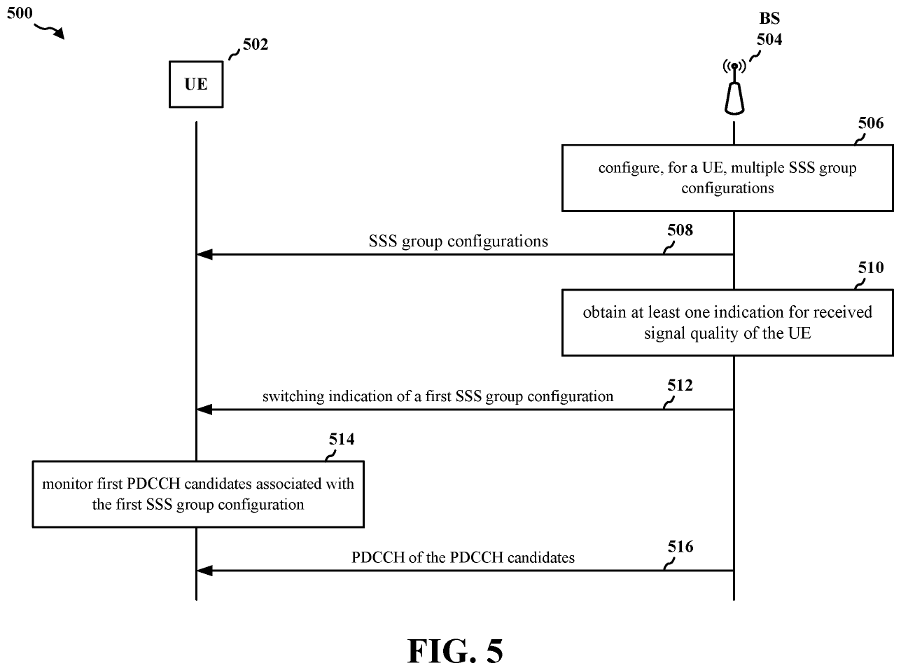

FIG. 5 is described below in the following context. A CORESET corresponds to a configurable set of physical resources in time and frequency that a UE uses to monitor for PDCCH/DCI. Each CORESET includes one or more resource blocks in the frequency domain and one or more symbols in the time domain. The frequency resources of a CORESET may be contiguous or non-contiguous. As an example, a CORESET might include multiple RBs in the frequency domain and 1, 2, or 3 contiguous symbols in the time domain. A Resource Element (RE) is a unit indicating one subcarrier in frequency over a single symbol in time. The REs within a CORESET may be organized in RE groups (REGs). An REG may correspond to one RB (e.g., 12 REs) during one OFDM symbol. A CCE may include Resource Element Groups (REGs), e.g., 6 REGs. The REGs within a CORESET may be numbered in increasing order in a time-first manner, starting with 0 for the first OFDM symbol and the lowest-numbered resource block in the control resource set. A UE can be configured with multiple CORESETs, each CORESET being associated with one CCE-to-REG mapping. The CCE-to-REG mapping may be interleaved or non-interleaved. A PDCCH may be carried by various numbers of CCEs, e.g., to accommodate different sizes of DCI, different coding rates, etc.

A CORESET may include multiple search spaces, which corresponds to a set of resources (e.g., in frequency and time) for which the UE is to perform blind decoding for control signaling (e.g., PDCCH) from the network. For example, the UE may be configured with at least one SSS. The SSS corresponds to a set of time and frequency resources where PDCCH for the UE may be transmitted from the network to the UE. The search space is an area within a CORESET that the UE uses to attempt to detect a specific PDCCH or DCI. The size of the search space differs for different aggregation levels. For example, the search space provides a set of CCEs at different aggregation levels and indicates how many candidates for the UE to attempt to decode at different aggregation levels. The SSS may be UE specific or common to multiple UEs. For example, a UE may be configured with one or more UE specific SSSs in an RRC message. The common SSS may indicate resources that each UE served by a cell is to monitor for control signaling such as system information (e.g., SIBs) or during RACH, among other examples.

A UE may be configured to blindly monitor, e.g., attempt to blindly decode, a number of PDCCH candidates of different DCI formats and different aggregation levels. The blind decoding may involve additional processing at a UE but may provide additional flexibility in scheduling and handling of different DCI formats.

Aspects herein provide for adaptive PDCCH monitoring based on received signal quality, or geometry (e.g., a UE DL signal quality/condition, such as SNR, SINR, etc.), via switching between search space groups based on received signal quality and PDCCH configurations based on received signal quality, for example.

FIG. 5 is a call flow diagram 500 for wireless communications, in various aspects. Call flow diagram 500 illustrates received signal quality dependent PDCCH monitoring adaptation, by a UE (e.g., a UE 502) that may communicate with a network node (a base station 504, such as a gNB or other type of base station, by way of example, as shown). Aspects described for the base station 504 may be performed by the base station in aggregated form and/or by one or more components of the base station 504 in disaggregated form. Additionally, or alternatively, the aspects may be performed by the UE 502 autonomously, in addition to, and/or in lieu of, operations of the base station 504.

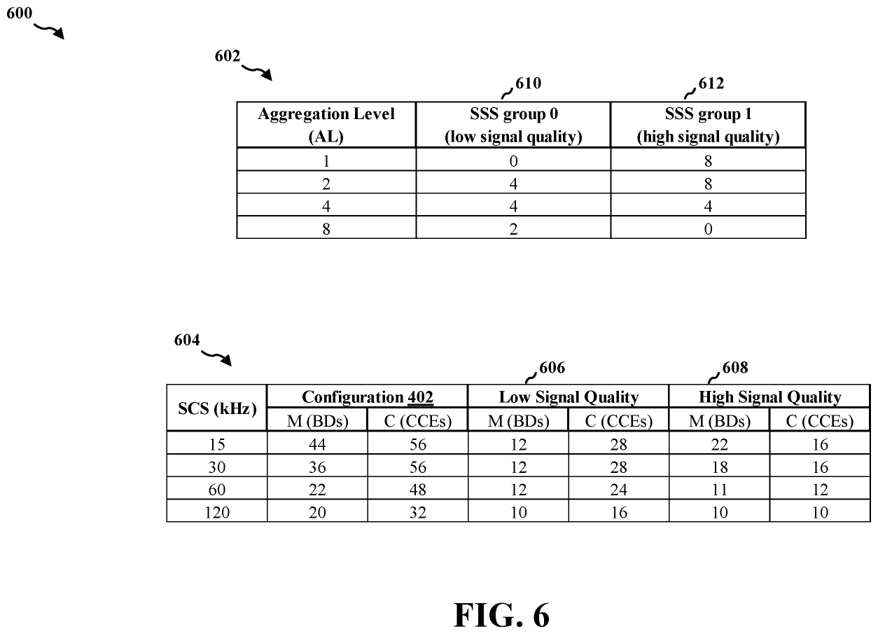

The base station 504 may configure (at 506), for the UE 502, multiple SSS group configurations 508. For example, the base station 504 may configure (at 506) the UE 502 with two or more SSS group configurations 508 that may each be associated with different number of candidates for each aggregation level. In aspects, configuring (at 506) the UE 502 with the multiple SSS group configurations 508 may include providing/transmitting the multiple SSS group configurations 508 from the base station 504 and receiving the multiple SSS group configurations 508 by the UE 502. The SSS group configurations 508 may indicate a number of DL channel (e.g., PDCCH) candidates to be monitored by the UE 502 for each aggregation level based on received signal quality of the UE 502, further details/examples for which are provided below with respect to FIG. 6. In aspects, each of the SSS group configurations 508 may include at least one resource candidate distribution for a respective resource aggregation level. The UE 502 may receive the multiple SSS group configurations 508 which may be provided/transmitted by the base station 504.

The base station 504 may obtain (at 510) at least one indication for received signal quality of the UE 502. In some aspects, the UE 502 may measure or estimate its received signal quality, e.g., for channels/signals received thereby, and may provide associated indicia to the base station 504. In other aspects, the base station 504 may obtain the received signal quality of the UE 502 by other mechanisms. The base station 504 may provide/transmit, and the UE 502 may receive, a switching indication 512 of a first SSS group configuration from the multiple SSS group configurations 508 based on a first received signal quality of the UE 502 that is obtained (at 510). In some aspects, the switching indication 512 may be included in downlink control information (DCI) from the base station 504. In some aspects, the switching indication 512 may be for at least one bandwidth part (BWP) or at least one carrier (e.g., a component carrier/CC).

The UE 502 may monitor (at 514) first PDCCH candidates associated with the first SSS group configuration. In aspects, a first PDCCH monitoring capacity associated with a first SSS group configuration based on the first received signal quality and a second PDCCH monitoring capacity associated with a second SSS group configuration based on a second received signal quality may be lower than a third PDCCH monitoring capacity that is independent of received signal qualities of the UE. The base station 504 may provide a PDCCH 516 for the UE 502 in at least one PDCCH candidate of the first SSS group configuration. In aspects, the UE 502 may receive the PDCCH 516 based on the monitoring (at 514) of the first PDCCH candidates associated with the first SSS group configuration.

FIG. 6 is a diagram 600 illustrating example SSS group configurations for monitoring adaptations based on signal quality of a UE, in various aspects. The diagram 600 shows a configuration 602 and a configuration 604, by way of example and not limitation. That is, the values provided for the configuration 602 and the configuration 604 are illustrative in nature for purposes of the description herein.

The configuration 602 illustrates an example of multiple SSS group configurations for signal quality-based PDCCH SSS group switching at a UE, shown as an SSS group 0 610 for low signal quality and an SSS group 1 612 for high signal quality, each of which includes at least one resource candidate distribution for a respective resource aggregation level. For instance, as noted herein, a base station (e.g., a gNB) may configure PDCCH monitoring adaptations based on a UE's received signal quality/geometry. In the context of the illustrated example for the configuration 602, a base station may configure two (or more) SSS groups (e.g., 610, 612) with different PDCCH candidate distributions across multiple aggregation levels.

In aspects, the SSS group 0 610 may utilize few or no resource candidates for a lowest aggregation level, relatively more resource candidates a for mid-level aggregation, and relatively few resource candidates for higher aggregation levels. In aspects, the SSS group 1 612 may utilize relatively higher resource candidates for lower aggregation level, relatively fewer resource candidates a for mid-level aggregation, and few or no resource candidates for higher aggregation levels. That is, for some aspects, a first SSS group configuration (e.g., SSS group 0 610) includes a lower number of PDCCH candidates in a first resource candidate distribution for a first resource aggregation level than a second SSS group configuration (e.g., SSS group 1 612), where the first SSS group configuration (e.g., 610) includes a higher number of PDCCH candidates in a second resource candidate distribution for a second resource aggregation level than the second SSS group configuration (e.g., 612), and where the first resource aggregation level is lower than the second resource aggregation level.

As described herein, a base station may trigger a switch (e.g., via a switching indication) between the SSS group 0 610 and the SSS group 1 612 for a UE. Such a switch may be based on an estimation or measurement of the UE's received signal quality/geometry condition. The base station may indicate such SSS group switching via a field in DCI (e.g., a field for SSS group switching).

The configuration 604 illustrates an example of PDCCH monitoring capacity for signal quality-based configurations at a UE. The configuration 604 shows a sub-configuration 606 for low signal quality and a sub-configuration 608 for high signal quality in contrast to the configuration 402, described above for FIG. 4. In this example, a base station, via SSS group configurations, may indicate a lower signal quality-dependent BD/CCE capacity for the sub-configuration 606 and the sub-configuration 608 than the BD/CCE capacity for the configuration 402. Thus, the configuration 402, which generally provides for a BD/CCE capacity to support PDCCH monitoring for both high/low signal qualities, utilizes more BDs/CCEs than the sub-configuration 606 and the sub-configuration 608.

It should be noted that for some aspects, for low signal quality, a base station cannot configure large number of PDCCH candidates (BDs) as PDCCH candidates with large aggregation levels are configured. Additionally, for high signal quality, a large number of non-overlapping CCEs may not be needed as PDCCH candidates with small aggregation levels are configured. Further, by reducing PDCCH monitoring capacity utilizations, PDCCH processing hardware complexity may be reduced or overall timeline/power usage for given PDCCH processing hardware may be reduced, and/or the like.

In aspects, a first PDCCH monitoring capacity associated with a first SSS group configuration (e.g., the sub-configuration 606) based on the first received signal quality and a second PDCCH monitoring capacity associated with a second SSS group configuration (e.g., the sub-configuration 608) based on a second received signal quality may be lower than a third PDCCH monitoring capacity (e.g., for configuration 402) that is independent of received signal qualities of the UE.

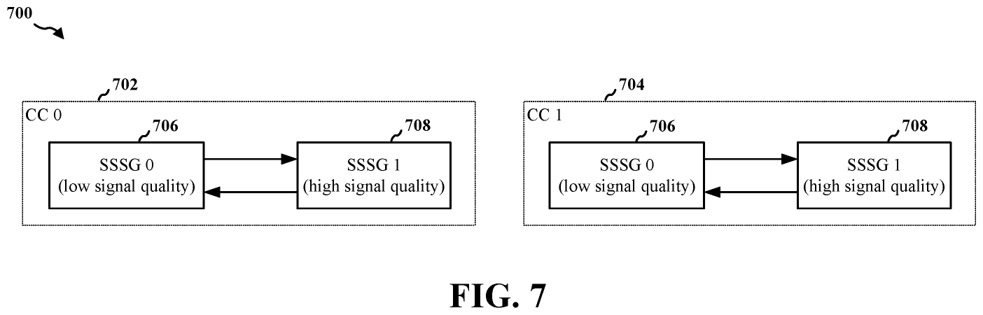

FIG. 7 is a diagram 700 illustrating example SSS group configurations for monitoring adaptations in component carriers (CCs) based on signal quality, in various aspects. Diagram 700 shows a configuration 702 for a first CC (CC 0) and a configuration 704 for a second CC (CC 1). The configuration 702 and the configuration 704 may each include multiple SSS group configurations: a SSS group configuration 706 (SSSG 0) and a SSS group configuration 708 (SSSG 1).

In various scenarios, when multiple DL CCs are configured in the same band, these CCs may have similar signal quality/geometry conditions. Aspects herein provide for configurations by which a base station may configure multiple SSS group configurations per CC, and may indicate for a UE to switch SSS groups for a group of BWPs/CCs. As shown in diagram 700, the SSS group SSSG 0 may be for low signal quality and may be configured in multiple CCs, while the SSS group SSSG 1 may be for high signal quality and may be also be configured in multiple CCs (e.g., CC 0 and CC 1). Accordingly, aspects provide for monitoring of and/or switching between SSS groups that correspond to specific CCs/BWPs.

In aspects, a base station may indicate (e.g., transmit/provide) SSS group switching to a UE via a field in DCI. In a first configuration, a DCI field for SSS group switching may be transmitted via an anchor CC and not via other cells in a group, e.g., via a primary cell (PCell). In a second configuration, SSS group switching may be transmitted via any cell in the group.

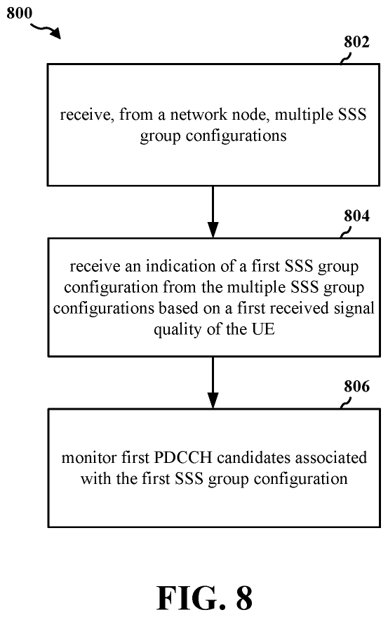

FIG. 8 is a flowchart 800 of a method of wireless communication. The method may be performed by a UE (e.g., the UE 104, 502; the apparatus 1204). In some aspects, the method may include aspects described in connection with the communication flow in FIG. 5 and/or aspects described in FIGS. 6, 7. The method provides for received signal quality (e.g., “geometry”) dependent DL (e.g., PDCCH) monitoring adaptations, that enables a UE to adapt monitoring through configurations of SSS groups that correspond to the received signal quality at the UE, which reduce the number of DL channel candidates to be monitored and the number of CCEs to be processed.

At 802, the UE receives, from a network node, multiple SSS group configurations. As an example, the reception may be performed, at least in part, by the component 198. FIGS. 6, 7 illustrate an example of a UE (e.g., the UE 502) receiving such configurations from a network node (e.g., the base station 504).

The base station 504 may configure (at 506), for the UE 502, multiple SSS group configurations 508 (e.g., 602, 604 in FIG. 6; 702, 704 in FIG. 7). For example, the base station 504 may configure (at 506) the UE 502 with two or more SSS group configurations 508 (e.g., 602, 604 in FIG. 6; 702, 704 in FIG. 7) that may each be associated with different CC aggregation levels. In aspects, configuring (at 506) the UE 502 with the multiple SSS group configurations 508 (e.g., 602, 604 in FIG. 6; 702, 704 in FIG. 7) may include providing/transmitting the multiple SSS group configurations 508 (e.g., 602, 604 in FIG. 6; 702, 704 in FIG. 7) from the base station 504 and receiving the multiple SSS group configurations 508 (e.g., 602, 604 in FIG. 6; 702, 704 in FIG. 7) by the UE 502. The SSS group configurations 508 (e.g., 602, 604 in FIG. 6; 702, 704 in FIG. 7) may indicate a number of DL channel (e.g., PDCCH) candidates to be monitored by the UE 502 for each aggregation level based on received signal quality of the UE 502. In aspects, each of the SSS group configurations 508 (e.g., 602, 604 in FIG. 6; 702, 704 in FIG. 7) may include at least one resource candidate distribution (e.g., 610, 612 in FIG. 6) for a respective resource aggregation level. The UE 502 may receive the multiple SSS group configurations 508 (e.g., 602, 604 in FIG. 6; 702, 704 in FIG. 7) which may be provided/transmitted by the base station 504.

At 804, the UE receives an indication of a first SSS group configuration from the multiple SSS group configurations based on a first received signal quality of the UE. As an example, the reception may be performed, at least in part, by the component 198. FIGS. 6, 7 illustrate an example of a UE (e.g., the UE 502) receiving such an indication from a network node (e.g., the base station 504).

The base station 504 may obtain (at 510) at least one indication for received signal quality of the UE 502. In some aspects, the UE 502 may measure or estimate its received signal quality, e.g., for channels/signals received thereby, and may provide associated indicia to the base station 504. In other aspects, the base station 504 may obtain the received signal quality of the UE 502 by other mechanisms. The base station 504 may provide/transmit, and the UE 502 may receive, a switching indication 512 of a first SSS group configuration from the multiple SSS group configurations 508 (e.g., 602, 604 in FIG. 6; 702, 704 in FIG. 7) based on a first received signal quality of the UE 502 that is obtained (at 510). In some aspects, the switching indication 512 may be included in downlink control information (DCI) from the base station 504. In some aspects, the switching indication 512 may be for at least one bandwidth part (BWP) or at least one carrier (e.g., a component carrier/CC).

At 806, the UE monitors first PDCCH candidates associated with the first SSS group configuration. As an example, the monitoring may be performed, at least in part, by the component 198. FIGS. 6, 7 illustrate an example of a UE (e.g., the UE 502) monitoring such candidates as provided from a network node (e.g., the base station 504).

The UE 502 may monitor (at 514) first PDCCH candidates associated with the first SSS group configuration. In aspects, a first PDCCH monitoring capacity (e.g., 606 in FIG. 6) associated with a first SSS group configuration (e.g., 612 in FIG. 6) based on the first received signal quality and a second PDCCH monitoring capacity (e.g., 608 in FIG. 6) associated with a second SSS group configuration (e.g., 612 in FIG. 6) based on a second received signal quality may be lower than a third PDCCH monitoring capacity (e.g., 402 in FIG. 4) that is independent of received signal qualities of the UE. The base station 504 may provide a PDCCH 516 for the UE 502 in at least one PDCCH candidate of the first SSS group configuration. In aspects, the UE 502 may receive the PDCCH 516 based on the monitoring (at 514) of the first PDCCH candidates associated with the first SSS group configuration.

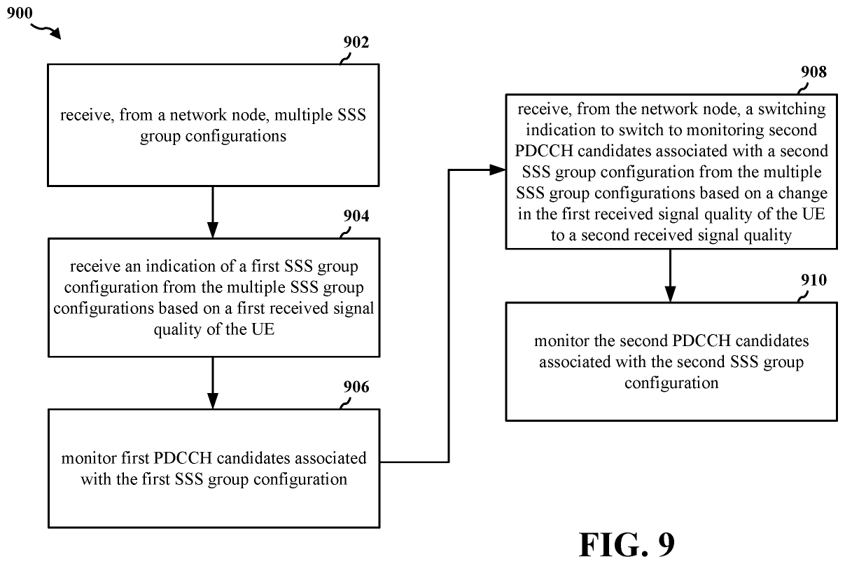

FIG. 9 is a flowchart 900 of a method of wireless communication. The method may be performed by a UE (e.g., the UE 104, 502; the apparatus 1204). In some aspects, the method may include aspects described in connection with the communication flow in FIG. 5 and/or aspects described in FIGS. 6, 7. The method provides for received signal quality (e.g., “geometry”) dependent DL (e.g., PDCCH) monitoring adaptations, that enables a UE to adapt monitoring through configurations of SSS groups that correspond to the received signal quality at the UE, which reduce the number of DL channel candidates to be monitored and the number of CCEs to be processed.

At 902, the UE receives, from a network node, multiple SSS group configurations. As an example, the reception may be performed, at least in part, by the component 198. FIGS. 6, 7 illustrate an example of a UE (e.g., the UE 502) receiving such configurations from a network node (e.g., the base station 504).

The base station 504 may configure, for the UE 502, multiple SSS group configurations 508 (e.g., 602, 604 in FIG. 6; 702, 704 in FIG. 7). For example, the base station 504 may configure (at 506) the UE 502 with two or more SSS group configurations 508 (e.g., 602, 604 in FIG. 6; 702, 704 in FIG. 7) that may each be associated with different number of candidates for each aggregation level. In aspects, configuring (at 506) the UE 502 with the multiple SSS group configurations 508 (e.g., 602, 604 in FIG. 6; 702, 704 in FIG. 7) may include providing/transmitting the multiple SSS group configurations 508 (e.g., 602, 604 in FIG. 6; 702, 704 in FIG. 7) from the base station 504 and receiving the multiple SSS group configurations 508 (e.g., 602, 604 in FIG. 6; 702, 704 in FIG. 7) by the UE 502. The SSS group configurations 508 (e.g., 602, 604 in FIG. 6; 702, 704 in FIG. 7) may indicate a number of DL channel (e.g., PDCCH) candidates to be monitored by the UE 502 for each aggregation level based on received signal quality of the UE 502. In aspects, each of the SSS group configurations 508 (e.g., 602, 604 in FIG. 6; 702, 704 in FIG. 7) may include at least one resource candidate distribution (e.g., 610, 612 in FIG. 6) for a respective resource aggregation level. The UE 502 may receive the multiple SSS group configurations 508 (e.g., 602, 604 in FIG. 6; 702, 704 in FIG. 7) which may be provided/transmitted by the base station 504.

At 904, the UE receives an indication of a first SSS group configuration from the multiple SSS group configurations based on a first received signal quality of the UE. As an example, the reception may be performed, at least in part, by the component 198. FIGS. 6, 7 illustrate an example of a UE (e.g., the UE 502) receiving such an indication from a network node (e.g., the base station 504).

The base station 504 may obtain (at 510) at least one indication for received signal quality of the UE 502. In some aspects, the UE 502 may measure or estimate its received signal quality, e.g., for channels/signals received thereby, and may provide associated indicia to the base station 504. In other aspects, the base station 504 may obtain the received signal quality of the UE 502 by other mechanisms. The base station 504 may provide/transmit, and the UE 502 may receive, a switching indication 512 of a first SSS group configuration from the multiple SSS group configurations 508 (e.g., 602, 604 in FIG. 6; 702, 704 in FIG. 7) based on a first received signal quality of the UE 502 that is obtained (at 510). In some aspects, the switching indication 512 may be included in downlink control information (DCI) from the base station 504. In some aspects, the switching indication 512 may be for at least one bandwidth part (BWP) or at least one carrier (e.g., a component carrier/CC).

At 906, the UE monitors first PDCCH candidates associated with the first SSS group configuration. As an example, the monitoring may be performed, at least in part, by the component 198. FIGS. 6, 7 illustrate an example of a UE (e.g., the UE 502) monitoring such candidates as provided from a network node (e.g., the base station 504).

The UE 502 may monitor (at 514) first PDCCH candidates associated with the first SSS group configuration. In aspects, a first PDCCH monitoring capacity (e.g., 606 in FIG. 6) associated with a first SSS group configuration (e.g., 612 in FIG. 6) based on the first received signal quality and a second PDCCH monitoring capacity (e.g., 608 in FIG. 6) associated with a second SSS group configuration (e.g., 612 in FIG. 6) based on a second received signal quality may be lower than a third PDCCH monitoring capacity (e.g., 402 in FIG. 4) that is independent of received signal qualities of the UE. The base station 504 may provide a PDCCH 516 for the UE 502 in at least one PDCCH candidate of the first SSS group configuration. In aspects, the UE 502 may receive the PDCCH 516 based on the monitoring (at 514) of the first PDCCH candidates associated with the first SSS group configuration.

At 908, the UE receives, from the network node, a switching indication to switch to monitoring second PDCCH candidates associated with a second SSS group configuration from the multiple SSS group configurations based on a change in the first received signal quality of the UE to a second received signal quality. As an example, the reception may be performed, at least in part, by the component 198. FIGS. 6, 7 illustrate an example of a UE (e.g., the UE 502) receiving such a switching indication from a network node (e.g., the base station 504).

The base station 504 may provide/transmit, and the UE 502 may receive, a switching indication (e.g., similar to 512 in FIG. 5) of a second SSS group configuration from the multiple SSS group configurations 508 (e.g., 602, 604 in FIG. 6; 702, 704 in FIG. 7) based on a second received signal quality of the UE 502 that is obtained (e.g., similar to 510 in FIG. 5). In aspects, the first received signal quality may be a lower level received signal quality than the second received signal quality, or vice versa. In some aspects, the switching indication may be included in downlink control information (DCI) from the base station 504. In some aspects, the switching indication may be for at least one bandwidth part (BWP) or at least one carrier (e.g., a component carrier/CC). In some aspects, the switching indication may be for at least one bandwidth part (BWP) or at least one carrier (e.g., a component carrier/CC). In aspects, the switching indication for the second SSS group configuration may be received on at least a first carrier.

At 910, the UE monitors the second PDCCH candidates associated with the second SSS group configuration. As an example, the monitoring may be performed, at least in part, by the component 198. FIGS. 6, 7 illustrate an example of a UE (e.g., the UE 502) monitoring such candidates as provided from a network node (e.g., the base station 504).

The UE 502 may monitor (e.g., as similarly described for 514) second PDCCH candidates associated with the second SSS group configuration. In aspects, a first PDCCH monitoring capacity (e.g., 606 in FIG. 6) associated with a first SSS group configuration (e.g., 612 in FIG. 6) based on the first received signal quality and a second PDCCH monitoring capacity (e.g., 608 in FIG. 6) associated with a second SSS group configuration (e.g., 612 in FIG. 6) based on a second received signal quality may be lower than a third PDCCH monitoring capacity (e.g., 402 in FIG. 4) that is independent of received signal qualities of the UE. The base station 504 may provide a PDCCH for the UE 502 in at least one PDCCH candidate of the second SSS group configuration. In aspects, the UE 502 may receive the PDCCH based on the monitoring of the second PDCCH candidates associated with the second SSS group configuration. In aspects for which the switching indication for the second SSS group configuration is received on at least a first carrier (e.g., for 908), UE 502 may monitor second PDCCH candidates based on the second SSS group configuration.

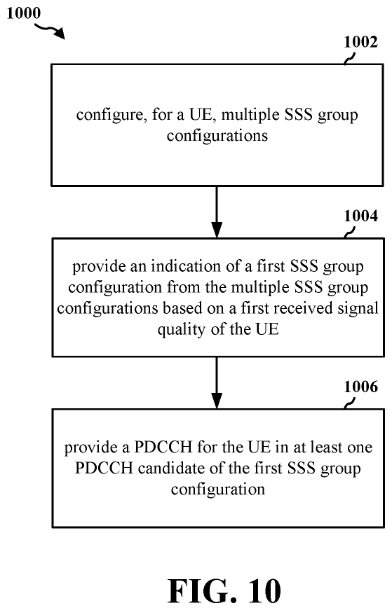

FIG. 10 is a flowchart 1000 of a method of wireless communication. The method may be performed by a base station or a network node (e.g., the base station 102, 504; the network entity 1202, 1302, _1260.). In some aspects, the method may include aspects described in connection with the communication flow in FIG. 5 and/or aspects described in FIGS. 6, 7. The method provides for received signal quality (e.g., “geometry”) dependent DL (e.g., PDCCH) monitoring adaptations, that enables a UE to adapt monitoring through configurations of SSS groups that correspond to the received signal quality at the UE, which reduce the number of DL channel candidates to be monitored and the number of CCEs to be processed.

At 1002, the base station/network node configures, for a UE, multiple SSS group configurations. As an example, the configuration may be performed, at least in part, by the component 199. FIGS. 6, 7 illustrate an example of a network node (e.g., the base station 504) configuring a UE (e.g., the UE 502) with such SSS group configurations.

The base station 504 may configure, for the UE 502, multiple SSS group configurations 508 (e.g., 602, 604 in FIG. 6; 702, 704 in FIG. 7). For example, the base station 504 may configure (at 506) the UE 502 with two or more SSS group configurations 508 (e.g., 602, 604 in FIG. 6; 702, 704 in FIG. 7) that may each be associated with different number of candidates per aggregation level. In aspects, configuring (at 506) the UE 502 with the multiple SSS group configurations 508 (e.g., 602, 604 in FIG. 6; 702, 704 in FIG. 7) may include providing/transmitting the multiple SSS group configurations 508 (e.g., 602, 604 in FIG. 6; 702, 704 in FIG. 7) to the UE and receiving the multiple SSS group configurations 508 (e.g., 602, 604 in FIG. 6; 702, 704 in FIG. 7) from the base station 504. The SSS group configurations 508 (e.g., 602, 604 in FIG. 6; 702, 704 in FIG. 7) may indicate a number of DL channel (e.g., PDCCH) candidates to be monitored by the UE 502 for each aggregation level based on received signal quality of the UE 502. In aspects, each of the SSS group configurations 508 (e.g., 602, 604 in FIG. 6; 702, 704 in FIG. 7) may include at least one resource candidate distribution (e.g., 610, 612 in FIG. 6) for a respective resource aggregation level. The UE 502 may receive the multiple SSS group configurations 508 (e.g., 602, 604 in FIG. 6; 702, 704 in FIG. 7) which may be provided/transmitted by the base station 504.

At 1004, the base station/network node provides an indication of a first SSS group configuration from the multiple SSS group configurations based on a first received signal quality of the UE. As an example, the provision may be performed, at least in part, by the component 199. FIGS. 6, 7 illustrate an example of a network node (e.g., the base station 504) providing such an indication to a UE (e.g., the UE 502).

The base station 504 may obtain (at 510) at least one indication for received signal quality of the UE 502. In some aspects, the UE 502 may measure or estimate its received signal quality, e.g., for channels/signals received thereby, and may provide associated indicia to the base station 504. In other aspects, the base station 504 may obtain the received signal quality of the UE 502 by other mechanisms. The base station 504 may provide/transmit, and the UE 502 may receive, a switching indication 512 of a first SSS group configuration from the multiple SSS group configurations 508 (e.g., 602, 604 in FIG. 6; 702, 704 in FIG. 7) based on a first received signal quality of the UE 502 that is obtained (at 510). In some aspects, the switching indication 512 may be included in downlink control information (DCI) from the base station 504. In some aspects, the switching indication 512 may be for at least one bandwidth part (BWP) or at least one carrier (e.g., a component carrier/CC).

At 1006, the base station/network node provides a PDCCH for the UE in at least one PDCCH candidate of the first SSS group configuration. As an example, the provision may be performed, at least in part, by the component 199. FIGS. 6, 7 illustrate an example of a network node (e.g., the base station 504) providing such a PDCCH to a UE (e.g., the UE 502).

The UE 502 may monitor (at 514) first PDCCH candidates associated with the first SSS group configuration. In aspects, a first PDCCH monitoring capacity (e.g., 606 in FIG. 6) associated with a first SSS group configuration (e.g., 612 in FIG. 6) based on the first received signal quality and a second PDCCH monitoring capacity (e.g., 608 in FIG. 6) associated with a second SSS group configuration (e.g., 612 in FIG. 6) based on a second received signal quality may be lower than a third PDCCH monitoring capacity (e.g., 402 in FIG. 4) that is independent of received signal qualities of the UE. The base station 504 may provide a PDCCH 516 for the UE 502 in at least one PDCCH candidate of the first SSS group configuration. In aspects, the UE 502 may receive the PDCCH 516 based on the monitoring (at 514) of the first PDCCH candidates associated with the first SSS group configuration.

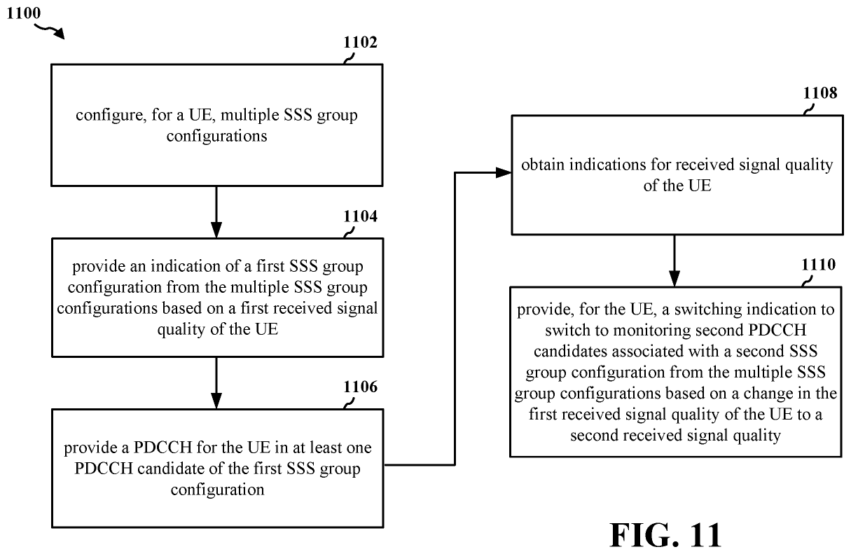

FIG. 11 is a flowchart 1100 of a method of wireless communication. The method may be performed by a base station/network node (e.g., the base station 102, 504; the network entity 1202, 1302, _1260.). In some aspects, the method may include aspects described in connection with the communication flow in FIG. 5 and/or aspects described in FIGS. 6, 7. The method provides for received signal quality (e.g., “geometry”) dependent DL (e.g., PDCCH) monitoring adaptations, that enables a UE to adapt monitoring through configurations of SSS groups that correspond to the received signal quality at the UE, which reduce the number of DL channel candidates to be monitored and the number of CCEs to be processed.

At 1102, the base station/network node configures, for a UE, multiple SSS group configurations. As an example, the configuration may be performed, at least in part, by the component 199. FIGS. 6, 7 illustrate an example of a network node (e.g., the base station 504) configuring a UE (e.g., the UE 502) with such SSS group configurations.

The base station 504 may configure, for the UE 502, multiple SSS group configurations 508 (e.g., 602, 604 in FIG. 6; 702, 704 in FIG. 7). For example, the base station 504 may configure (at 506) the UE 502 with two or more SSS group configurations 508 (e.g., 602, 604 in FIG. 6; 702, 704 in FIG. 7) that may each be associated with different number of candidates for each aggregation level. In aspects, configuring (at 506) the UE 502 with the multiple SSS group configurations 508 (e.g., 602, 604 in FIG. 6; 702, 704 in FIG. 7) may include providing/transmitting the multiple SSS group configurations 508 (e.g., 602, 604 in FIG. 6; 702, 704 in FIG. 7) from the base station 504 and receiving the multiple SSS group configurations 508 (e.g., 602, 604 in FIG. 6; 702, 704 in FIG. 7) by the UE 502. The SSS group configurations 508 (e.g., 602, 604 in FIG. 6; 702, 704 in FIG. 7) may indicate a number of DL channel (e.g., PDCCH) candidates to be monitored by the UE 502 for each aggregation level based on received signal quality of the UE 502. In aspects, each of the SSS group configurations 508 (e.g., 602, 604 in FIG. 6; 702, 704 in FIG. 7) may include at least one resource candidate distribution (e.g., 610, 612 in FIG. 6) for a respective resource aggregation level. The UE 502 may receive the multiple SSS group configurations 508 (e.g., 602, 604 in FIG. 6; 702, 704 in FIG. 7) which may be provided/transmitted by the base station 504.

At 1104, the base station/network node provides an indication of a first SSS group configuration from the multiple SSS group configurations based on a first received signal quality of the UE. As an example, the provision may be performed, at least in part, by the component 199. FIGS. 6, 7 illustrate an example of a network node (e.g., the base station 504) providing such an indication to a UE (e.g., the UE 502).

The base station 504 may obtain (at 510) at least one indication for received signal quality of the UE 502. In some aspects, the UE 502 may measure or estimate its received signal quality, e.g., for channels/signals received thereby, and may provide associated indicia to the base station 504. In other aspects, the base station 504 may obtain the received signal quality of the UE 502 by other mechanisms. The base station 504 may provide/transmit, and the UE 502 may receive, a switching indication 512 of a first SSS group configuration from the multiple SSS group configurations 508 (e.g., 602, 604 in FIG. 6; 702, 704 in FIG. 7) based on a first received signal quality of the UE 502 that is obtained (at 510). In some aspects, the switching indication 512 may be included in downlink control information (DCI) from the base station 504. In some aspects, the switching indication 512 may be for at least one bandwidth part (BWP) or at least one carrier (e.g., a component carrier/CC).

At 1106, the base station/network node provides a PDCCH for the UE in at least one PDCCH candidate of the first SSS group configuration. As an example, the provision may be performed, at least in part, by the component 199. FIGS. 6, 7 illustrate an example of a network node (e.g., the base station 504) providing such a PDCCH to a UE (e.g., the UE 502).

The UE 502 may monitor (at 514) first PDCCH candidates associated with the first SSS group configuration. In aspects, a first PDCCH monitoring capacity (e.g., 606 in FIG. 6) associated with a first SSS group configuration (e.g., 612 in FIG. 6) based on the first received signal quality and a second PDCCH monitoring capacity (e.g., 608 in FIG. 6) associated with a second SSS group configuration (e.g., 612 in FIG. 6) based on a second received signal quality may be lower than a third PDCCH monitoring capacity (e.g., 402 in FIG. 4) that is independent of received signal qualities of the UE. The base station 504 may provide a PDCCH 516 for the UE 502 in at least one PDCCH candidate of the first SSS group configuration. In aspects, the UE 502 may receive the PDCCH 516 based on the monitoring (at 514) of the first PDCCH candidates associated with the first SSS group configuration.

At 1108, the base station/network node obtains indications for received signal quality of the UE. As an example, the obtaining may be performed, at least in part, by the component 199. FIGS. 6, 7 illustrate an example of a network node (e.g., the base station 504) obtaining such indications for received signal quality from a UE (e.g., the UE 502).

The base station 504 may obtain (e.g., as similarly for 510 in FIG. 5) at least one indication for received signal quality of the UE 502. In some aspects, the UE 502 may measure or estimate its received signal quality, e.g., for channels/signals received thereby, and may provide associated indicia to the base station 504. In other aspects, the base station 504 may obtain the received signal quality of the UE 502 by other mechanisms. In aspects, a first received signal quality (e.g., for a first SSS group configuration (e.g., 610 in FIG. 6)) may be a lower level received signal quality than a second received signal quality (e.g., for a second SSS group configuration (e.g., 612 in FIG. 6)), or vice versa.

At 1110, the base station/network node provides, for the UE, a switching indication to switch to monitoring second PDCCH candidates associated with a second SSS group configuration from the multiple SSS group configurations based on a change in the first received signal quality of the UE to a second received signal quality. As an example, the provision may be performed, at least in part, by the component 199. FIGS. 6, 7 illustrate an example of a network node (e.g., the base station 504) providing such a switching indication to a UE (e.g., the UE 502).

The base station 504 may provide/transmit, and the UE 502 may receive, a switching indication (e.g., similarly as for 512 in FIG. 5) of a second SSS group configuration from the multiple SSS group configurations 508 (e.g., 602, 604 in FIG. 6; 702, 704 in FIG. 7) based on a second received signal quality of the UE 502 that is obtained (e.g., as similarly for 510). In some aspects, the switching indication may be included in downlink control information (DCI) from the base station 504. In some aspects, the switching indication may be for at least one bandwidth part (BWP) or at least one carrier (e.g., a component carrier/CC). In aspects, the switching indication for the second SSS group configuration may be received on at least a first carrier, and in such aspects the UE 502 may monitor second PDCCH candidates based on the second SSS group configuration.

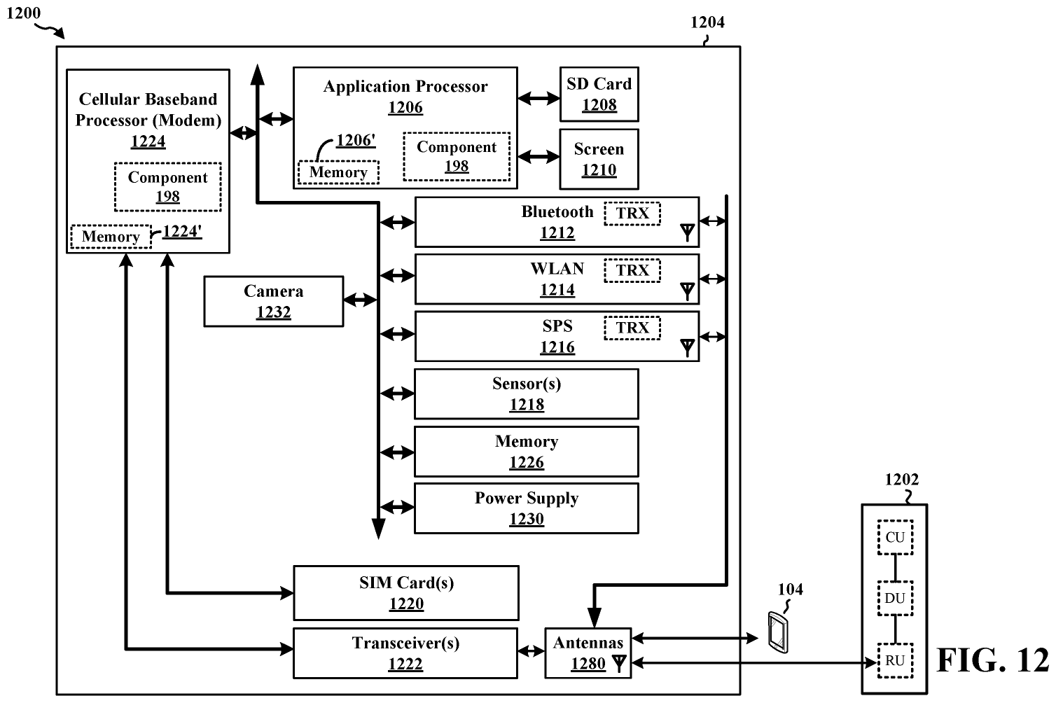

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359.

In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the component 198 may be configured to receive, from a network node, multiple SSS group configurations. The component 198 may be further configured to receive an indication of a first SSS group configuration from the multiple SSS group configurations based on a first received signal quality of the UE. The component 198 may be further configured to monitor first PDCCH candidates associated with the first SSS group configuration. The component 198 may be configured to receive, from the network node, a switching indication to switch to monitoring second PDCCH candidates associated with a second SSS group configuration from the multiple SSS group configurations based on a change in the first received signal quality of the UE to a second received signal quality. The component 198 may be configured to monitor the second PDCCH candidates associated with the second SSS group configuration. The component 199 may be further configured to perform any of the aspects described in connection with the flowcharts in any of FIGS. 8-11, and/or any of the aspects performed by a UE for any of FIGS. 5-7. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving, from a network node, multiple SSS group configurations. In the configuration, the apparatus 1204, and in particular the cellular baseband processor(s) 1224 and/or the application processor(s) 1206, may include means for receiving an indication of a first SSS group configuration from the multiple SSS group configurations based on a first received signal quality of the UE. In the configuration, the apparatus 1204, and in particular the cellular baseband processor(s) 1224 and/or the application processor(s) 1206, may include means for monitoring first PDCCH candidates associated with the first SSS group configuration. In one configuration, the apparatus 1204, and in particular the cellular baseband processor(s) 1224 and/or the application processor(s) 1206, may include means for receiving, from the network node, a switching indication to switch to monitoring second PDCCH candidates associated with a second SSS group configuration from the multiple SSS group configurations based on a change in the first received signal quality of the UE to a second received signal quality. In one configuration, the apparatus 1204, and in particular the cellular baseband processor(s) 1224 and/or the application processor(s) 1206, may include means for monitoring the second PDCCH candidates associated with the second SSS group configuration. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

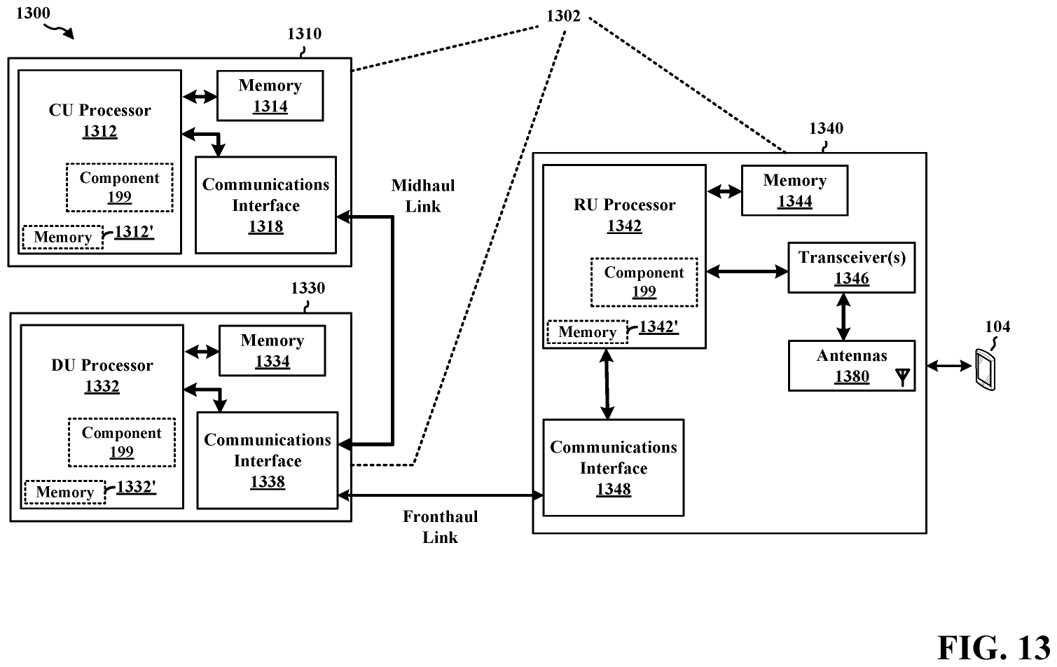

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure, for a UE, multiple SSS group configurations. The component 199 may be further configured to provide an indication of a first SSS group configuration from the multiple SSS group configurations based on a first received signal quality of the UE. The component 199 may be further configured to provide a PDCCH for the UE in at least one PDCCH candidate of the first SSS group configuration. The component 199 may be configured to obtain at least one indication for received signal quality of the UE. The component 199 may be configured to provide, for the UE, a switching indication to switch to monitoring second PDCCH candidates associated with a second SSS group configuration from the multiple SSS group configurations based on a change in the first received signal quality of the UE to a second received signal quality. The component 199 may be further configured to perform any of the aspects described in connection with the flowcharts in any of FIGS. 8-11, and/or any of the aspects performed by a UE for any of FIGS. 5-7. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for configuring, for a UE, multiple SSS group configurations. In the configuration, the network entity 1302 may include means for providing an indication of a first SSS group configuration from the multiple SSS group configurations based on a first received signal quality of the UE. In the configuration, the network entity 1302 may include means for providing a PDCCH for the UE in at least one PDCCH candidate of the first SSS group configuration. In one configuration, the network entity 1302 may include means for obtaining at least one indication for received signal quality of the UE. In one configuration, the network entity 1302 may include means for providing, for the UE, a switching indication to switch to monitoring second PDCCH candidates associated with a second SSS group configuration from the multiple SSS group configurations based on a change in the first received signal quality of the UE to a second received signal quality. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

Search space monitoring for DL channels, such as PDCCH, may enable a UE to support DL channel monitoring capacities for a given number of BDs and CCEs associated with different SCS configurations. A UE may be configured with a number of SSSs per carrier where DL channel candidates are configured by a base station in association with aggregation levels, and different SSS groups may be configured for varying traffic conditions. However, existing PDCCH monitoring for large numbers of PDCCH candidates and PDCCH processing for large number of CCEs may lead to issues with processing, delays, and power consumption. For instance, increased hardware complexity for PDCCH processing (e.g., channel estimation, de-mapping, decoding, memory, etc.) may result from monitoring/processing large numbers of PDCCH candidates/CCEs. Additionally, increased PDCCH decoding delays (e.g., impacts in overall DL/UL processing timelines, etc.), as well as increased power consumption (e.g., due to delays entering usleep (or “micro-sleep”), may also result from monitoring/processing large numbers of PDCCH candidates/CCEs. Further, existing monitoring does not provide for configuring SSS groups based on received signal quality at a UE.

Aspects herein for received signal quality (e.g., “geometry”) dependent DL monitoring adaptations utilized UE signal quality, or received signal quality, to adapt monitoring through configurations of SSS groups that correspond to the received signal quality at the UE. Accordingly, by configuring multiple SSS group configurations for a UE and activating a given SSS group configuration based on the received signal quality (e.g., geometry or SINR) of the UE, the described aspects herein may be used to decrease processing utilization, delays, and power consumption at the UE. UEs may thus be configured to reduce the number of DL channel candidates to be monitored and the number of CCEs to be processed, which may reduce the hardware complexity for DL channel processing (e.g., channel estimation, de-mapping, decoding, memory, etc.), the PDCCH decoding delay (e.g., impacts of the overall DL/UL processing timelines), and the power consumption (e.g., due to delays in entering usleep).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), including: receiving, from a network node, multiple search space set (SSS) group configurations; receiving an indication of a first SSS group configuration from the multiple SSS group configurations based on a first received signal quality of the UE; and monitoring first physical downlink control channel (PDCCH) candidates associated with the first SSS group configuration.
Aspect 2 is the method of aspect 1, where each SSS group configuration includes at least one resource candidate distribution for a respective resource aggregation level.
Aspect 3 is the method of aspect 2, where the first SSS group configuration includes a lower number of PDCCH candidates in a first resource candidate distribution for a first resource aggregation level than a second SSS group configuration, where the first SSS group configuration includes a higher number of PDCCH candidates in a second resource candidate distribution for a second resource aggregation level than the second SSS group configuration, and where the first resource aggregation level is lower than the second resource aggregation level.
Aspect 4 is the method of aspect 1, further including: receiving, from the network node, a switching indication to switch to monitoring second PDCCH candidates associated with a second SSS group configuration from the multiple SSS group configurations based on a change in the first received signal quality of the UE to a second received signal quality; and monitoring the second PDCCH candidates associated with the second SSS group configuration.
Aspect 5 is the method of aspect 4, where the switching indication is included in downlink control information (DCI).
Aspect 6 is the method of aspect 4, where the switching indication is for at least one bandwidth part (BWP) or at least one carrier.
Aspect 7 is the method of aspect 4, where the switching indication for the second SSS group configuration is received on at least a first carrier, and where monitoring the second PDCCH candidates includes: monitoring the second PDCCH candidates on multiple carriers based on the second SSS group configuration.
Aspect 8 is the method of aspect 7, where the first carrier is a primary cell (PCell).
Aspect 9 is the method of aspect 4, where the first received signal quality is a lower level received signal quality than the second received signal quality.
Aspect 10 is the method of aspect 1, where a first PDCCH monitoring capacity associated with a first SSS group configuration based on the first received signal quality and a second PDCCH monitoring capacity associated with a second SSS group configuration based on a second received signal quality are lower than a third PDCCH monitoring capacity that is independent of received signal qualities of the UE.
Aspect 11 is a method of wireless communication at a network node, including: configuring, for a user equipment (UE), multiple search space set (SSS) group configurations; providing an indication of a first SSS group configuration from the multiple SSS group configurations based on a first received signal quality of the UE; and providing a physical downlink control channel (PDCCH) for the UE in at least one PDCCH candidate of the first SSS group configuration.
Aspect 12 is the method of aspect 11, where each SSS group configuration includes at least one resource candidate distribution for a respective resource aggregation level.
Aspect 13 is the method of aspect 12, where the first SSS group configuration includes a lower number of PDCCH candidates in a first resource candidate distribution for a first resource aggregation level than a second SSS group configuration, where the first SSS group configuration includes a higher number of PDCCH candidates in a second resource candidate distribution for a second resource aggregation level than the second SSS group configuration, and where the first resource aggregation level is lower than the second resource aggregation level.
Aspect 14 is the method of aspect 11, further including: obtaining at least one indication for received signal quality of the UE; and providing, for the UE, a switching indication to switch to monitoring second PDCCH candidates associated with a second SSS group configuration from the multiple SSS group configurations based on a change in the first received signal quality of the UE to a second received signal quality.
Aspect 15 is the method of aspect 14, where the switching indication is included in downlink control information (DCI).
Aspect 16 is the method of aspect 14, where the switching indication is for at least one bandwidth part (BWP) or at least one carrier.
Aspect 17 is the method of aspect 14, where the switching indication for the second SSS group configuration is provided on at least a first carrier.
Aspect 18 is the method of aspect 17, where the first carrier is a primary cell (PCell).
Aspect 19 is the method of aspect 14, where the first received signal quality is a lower level received signal quality than the second received signal quality.
Aspect 20 is the method of aspect 11, where a first PDCCH monitoring capacity associated with a first SSS group configuration based on the first received signal quality and a second PDCCH monitoring capacity associated with a second SSS group configuration based on a second received signal quality are lower than a third PDCCH monitoring capacity that is independent of received signal qualities of the UE.
Aspect 21 is an apparatus for wireless communication including means for implementing any of aspects 1 to 10.
Aspect 22 is a computer-readable medium (e.g., a non-transitory computer-readable medium) storing computer executable code, the code when executed by at least one processor causes the at least one processor, individually or in any combination, to implement any of aspects 1 to 10.
Aspect 23 is an apparatus for wireless communication at a network node. The apparatus includes a memory; and at least one processor coupled to the memory and, based at least in part on information stored in the memory, the at least one processor, individually or in any combination, is configured to implement any of aspects 1 to 10.
Aspect 24 is the apparatus of aspect 23, further including at least one of a transceiver or an antenna coupled to the at least one processor.
Aspect 25 is an apparatus for wireless communication including means for implementing any of aspects 11 to 20.
Aspect 26 is a computer-readable medium (e.g., a non-transitory computer-readable medium) storing computer executable code, the code when executed by at least one processor causes the at least one processor, individually or in any combination, to implement any of aspects 11 to 20.
Aspect 27 is an apparatus for wireless communication at a network node. The apparatus includes a memory; and at least one processor coupled to the memory and, based at least in part on information stored in the memory, the at least one processor, individually or in any combination, is configured to implement any of aspects 11 to 20.
Aspect 28 is the apparatus of aspect 27, further including at least one of a transceiver or an antenna coupled to the at least one processor.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, multiple search space set (SSS) group configurations;
receive an indication of a first SSS group configuration from the multiple SSS group configurations based on a first received signal quality of the UE; and
monitor first physical downlink control channel (PDCCH) candidates associated with the first SSS group configuration.

2. The apparatus of claim 1, wherein each SSS group configuration includes at least one resource candidate distribution for a respective resource aggregation level.

3. The apparatus of claim 2, wherein the first SSS group configuration includes a lower number of PDCCH candidates in a first resource candidate distribution for a first resource aggregation level than a second SSS group configuration, wherein the first SSS group configuration includes a higher number of PDCCH candidates in a second resource candidate distribution for a second resource aggregation level than the second SSS group configuration, and wherein the first resource aggregation level is lower than the second resource aggregation level.

4. The apparatus of claim 1, wherein the at least one processor, individually or in any combination, is further configured to:
receive, from the network node, a switching indication to switch to monitoring second PDCCH candidates associated with a second SSS group configuration from the multiple SSS group configurations based on a change in the first received signal quality of the UE to a second received signal quality; and
monitor the second PDCCH candidates associated with the second SSS group configuration.

5. The apparatus of claim 4, wherein the switching indication is comprised in downlink control information (DCI).

6. The apparatus of claim 4, wherein the switching indication is for at least one bandwidth part (BWP) or at least one carrier.

7. The apparatus of claim 4, wherein the switching indication for the second SSS group configuration is received on at least a first carrier, and wherein to monitor the second PDCCH candidates, the at least one processor, individually or in any combination, is configured to:
monitor the second PDCCH candidates on multiple carriers based on the second SSS group configuration.

8. The apparatus of claim 7, wherein the first carrier is a primary cell (PCell).

9. The apparatus of claim 4, wherein the first received signal quality is a lower level received signal quality than the second received signal quality.

10. The apparatus of claim 1, wherein a first PDCCH monitoring capacity associated with a first SSS group configuration based on the first received signal quality and a second PDCCH monitoring capacity associated with a second SSS group configuration based on a second received signal quality are lower than a third PDCCH monitoring capacity that is independent of received signal qualities of the UE.

11. An apparatus for wireless communication at a network node, comprising:
at least one memory; and
at least one processor coupled to the at least one memory and, based at least in part on information stored in the at least one memory, the at least one processor, individually or in any combination, is configured to:
configure, for a user equipment (UE), multiple search space set (SSS) group configurations;
provide an indication of a first SSS group configuration from the multiple SSS group configurations based on a first received signal quality of the UE; and
provide a physical downlink control channel (PDCCH) for the UE in at least one PDCCH candidate of the first SSS group configuration.

12. The apparatus of claim 11, wherein each SSS group configuration includes at least one resource candidate distribution for a respective resource aggregation level.

13. The apparatus of claim 12, wherein the first SSS group configuration includes a lower number of PDCCH candidates in a first resource candidate distribution for a first resource aggregation level than a second SSS group configuration, wherein the first SSS group configuration includes a higher number of PDCCH candidates in a second resource candidate distribution for a second resource aggregation level than the second SSS group configuration, and wherein the first resource aggregation level is lower than the second resource aggregation level.

14. The apparatus of claim 11, wherein the at least one processor, individually or in any combination, is further configured to:
obtain at least one indication for received signal quality of the UE; and
provide, for the UE, a switching indication to switch to monitoring second PDCCH candidates associated with a second SSS group configuration from the multiple SSS group configurations based on a change in the first received signal quality of the UE to a second received signal quality.

15. The apparatus of claim 14, wherein the switching indication is comprised in downlink control information (DCI).

16. The apparatus of claim 14, wherein the switching indication is for at least one bandwidth part (BWP) or at least one carrier.

17. The apparatus of claim 14, wherein the switching indication for the second SSS group configuration is provided on at least a first carrier.

18. The apparatus of claim 17, wherein the first carrier is a primary cell (PCell).

19. The apparatus of claim 14, wherein the first received signal quality is a lower level received signal quality than the second received signal quality.

20. The apparatus of claim 11, wherein a first PDCCH monitoring capacity associated with a first SSS group configuration based on the first received signal quality and a second PDCCH monitoring capacity associated with a second SSS group configuration based on a second received signal quality are lower than a third PDCCH monitoring capacity that is independent of received signal qualities of the UE.

21. A method of wireless communication at a user equipment (UE), comprising:
receiving, from a network node, multiple search space set (SSS) group configurations;
receiving an indication of a first SSS group configuration from the multiple SSS group configurations based on a first received signal quality of the UE; and
monitoring first physical downlink control channel (PDCCH) candidates associated with the first SSS group configuration.

22. The method of claim 21, wherein each SSS group configuration includes at least one resource candidate distribution for a respective resource aggregation level.

23. The method of claim 22, wherein the first SSS group configuration includes a lower number of PDCCH candidates in a first resource candidate distribution for a first resource aggregation level than a second SSS group configuration, wherein the first SSS group configuration includes a higher number of PDCCH candidates in a second resource candidate distribution for a second resource aggregation level than the second SSS group configuration, and wherein the first resource aggregation level is lower than the second resource aggregation level.

24. The method of claim 21, further comprising:
receiving, from the network node, a switching indication to switch to monitoring second PDCCH candidates associated with a second SSS group configuration from the multiple SSS group configurations based on a change in the first received signal quality of the UE to a second received signal quality; and
monitoring the second PDCCH candidates associated with the second SSS group configuration.

25. The method of claim 24, wherein the switching indication is comprised in downlink control information (DCI);
wherein the switching indication is for at least one bandwidth part (BWP) or at least one carrier;
wherein the switching indication for the second SSS group configuration is received on at least a first carrier, and wherein monitoring the second PDCCH candidates comprises: monitoring the second PDCCH candidates on multiple carriers based on the second SSS group configuration; or
wherein the first received signal quality is a lower level received signal quality than the second received signal quality.

26. A method of wireless communication at a network node, comprising:
configuring, for a user equipment (UE), multiple search space set (SSS) group configurations;
providing an indication of a first SSS group configuration from the multiple SSS group configurations based on a first received signal quality of the UE; and
providing a physical downlink control channel (PDCCH) for the UE in at least one PDCCH candidate of the first SSS group configuration.

27. The method of claim 26, wherein each SSS group configuration includes at least one resource candidate distribution for a respective resource aggregation level.

28. The method of claim 27, wherein the first SSS group configuration includes a lower number of PDCCH candidates in a first resource candidate distribution for a first resource aggregation level than a second SSS group configuration, wherein the first SSS group configuration includes a higher number of PDCCH candidates in a second resource candidate distribution for a second resource aggregation level than the second SSS group configuration, and wherein the first resource aggregation level is lower than the second resource aggregation level.

29. The method of claim 26, further comprising:
obtaining at least one indication for received signal quality of the UE; and
providing, for the UE, a switching indication to switch to monitoring second PDCCH candidates associated with a second SSS group configuration from the multiple SSS group configurations based on a change in the first received signal quality of the UE to a second received signal quality.

30. The method of claim 29, wherein the switching indication is comprised in downlink control information (DCI);
wherein the switching indication is for at least one bandwidth part (BWP) or at least one carrier;
wherein the switching indication for the second SSS group configuration is provided on at least a first carrier; or
wherein the first received signal quality is a lower level received signal quality than the second received signal quality.
